(19) United States
(12) Patent Application Publication
(10) Pub. No.: US 2025/0382913 A1
(43) Pub. Date: Dec. 18, 2025

(54) ROTOR ENGINE

(71) Applicant: Shenzhen Shuangyin Power Technology Co., Ltd, Shenzhen (CN)

(72) Inventor: Weidong Feng, Shenzhen (CN)

(21) Appl. No.: 19/303,649

(22) Filed: Aug. 19, 2025

Related U.S. Application Data
(63) Continuation of application No. PCT/CN2024/091559, filed on May 8, 2024.

(30) Foreign Application Priority Data
Aug. 4, 2023 (CN) 202310984191.9

(51) Int. Cl. F02B 55/02; F02B 55/08

(52) U.S. Cl. CPC F02B 55/02; F02B 55/08

(57) ABSTRACT

A rotor engine, comprising: a cylinder body, a rotor, and two link mechanisms, wherein a rotor working space runs through the inside of the cylinder body, and the rotor is arranged in the rotor working space; the rotor comprises a rotating shaft and two semi-rotors, wherein the rotating shaft extends along an axis of the rotor working space, and each semi-rotor comprises a rotor plate and a plurality of rotor vanes thereon, the two rotor plates being spaced apart, outer peripheral walls of the two rotor plates abutting against the cylinder body, the rotor vanes on the two rotor plates extending in opposite directions to seal against each other, and inner and outer side walls of the rotor vanes respectively sealing against an outer peripheral wall of the rotating shaft and an inner peripheral wall of the rotor working space.

### CROSS-REFERENCE TO RELATED APPLICATIONS

This application is a continuation of International Application No. PCT/CN2024/091559, filed on May 8, 2024, which claims the priority of the Chinese patent application filed with the China Patent Office on Aug. 4, 2023, with application number CN202310984191.9 and title “A Rotor Engine”, all contents of which are incorporated by reference in this application.

### FIELD OF THE INVENTION

The present application relates to the technical field of engines, in particular to a rotor engine.

### BACKGROUND OF THE INVENTION

Rotor engines have many advantages compared with conventional engines, such as simple and compact structure, high speed, low noise, and high power per liter. However, the only rotor engine that has been commercialized is the triangular rotor engine, and its application range is relatively small.

The main reason why the triangular rotor engine has not been widely used is that the contact between the triangular rotor and the inner wall of the cylinder body is linear, and the contact angle is constantly changing. The linear contact causes the rotor and the cylinder body to wear quickly, and it is difficult to seal the engine working chamber. If the working chamber is not sealed tightly, it will cause emissions to exceed the standard and the compression ratio will be limited.

### TECHNICAL ISSUES

The present application provides a rotor engine that have a high degree of sealing between a rotor and a cylinder body.

### Technical Solutions

The embodiment of the present application provides a rotor engine, which includes: a cylinder body, a rotor and two link mechanisms;
a circular rotor working space runs through the inside of the cylinder body;
the rotor is arranged in the rotor working space, and the rotor comprises a rotating shaft and two oppositely arranged semi-rotors; the rotating shaft extends along the axis of the rotor working space; the semi-rotor comprises a rotor plate and a plurality of rotor vanes arranged on the rotor plate, the two rotor plates are sleeved on the rotating shaft at intervals, and the outer peripheral wall of the rotor plate abuts against the inner peripheral wall of the rotor working space; the plurality of rotor vanes on one rotor plate all extend along the axial direction of the rotating shaft to seal against the other rotor plate, and the angle between any two adjacent rotor vanes on the same rotor plate is equal, and the inner and outer side walls of the rotor vanes are respectively sealed against the outer peripheral wall of the rotating shaft and the inner peripheral wall of the rotor working space, and the inner peripheral wall of the rotor working space, the two adjacent rotor vanes, the two rotor plates and the rotating shaft enclose a working chamber for combustion and work;
two link mechanisms are arranged on the outer side of the rotor, and the link mechanisms are transmission-connected to the rotating shaft and the adjacent rotor plates. One semi-rotor rotates to drive the rotating shaft to rotate through the link mechanism, and the rotating shaft can drive the other semi-rotor to rotate through another link mechanism, so that an angle is formed between any two adjacent rotor vanes.

In the rotor engine, the rotor engine further comprises two end covers, the end covers are detachably covered on the two ends of the cylinder body, a receiving space is recessed on one side of the end cover facing the link mechanism, and the inner peripheral wall of the receiving space encloses a guide ring;

The link mechanism is accommodated in the accommodating space, and the link mechanism includes a phase roller, a fixed frame and a movable part. The phase roller is connected to the outer wall of the rotor plate to rotate with the rotor plate, the fixed frame is connected to the rotating shaft to rotate with the rotating shaft, and the movable part is rotatably connected to the fixed frame; the phase roller rotates around the rotating shaft to abut and squeeze the movable part, the movable part can abut the guide ring and move along the guide ring, and the movable part moves to drive the fixed frame and the rotating shaft to rotate.

In the rotor engine, the link mechanism includes two phase rollers, a fixed frame and two movable parts. The two phase rollers are symmetrically arranged relative to the rotating shaft. The fixed frame extends in a direction perpendicular to the arrangement direction of the two phase rollers. The rotating shaft is accommodated in the middle of the fixed frame. A movable part is rotatably arranged at both ends of the fixed frame. The movable part extends along the arrangement direction of the phase rollers. The movable part includes two movable bearings arranged at both ends thereof, and the movable bearings are supported on the guide ring.

In the rotor engine, the movable part includes two movable walls, a connecting bearing and two movable bearings. The two movable walls extend along the arrangement direction of the phase rollers. Both ends of the two movable walls are abutted against the phase rollers. The connecting bearings and the movable bearings are located between the two movable walls. The connecting bearings are located in the middle of the movable walls. The movable wall is rotatably connected to one end of the fixed frame through the connecting bearings. The movable bearings are located at both ends of the movable walls and partially exceed the movable walls so that the movable bearings can be rotatably abutted against the guide ring.

In the rotor engine, the movable part further comprises a reinforcing wall, which is arranged on a side of the two movable walls away from the rotating shaft, and the reinforcing wall extends along an extension direction of the movable wall, and the reinforcing wall connects the two movable walls.

In the rotor engine, rotating washers are sleeved on both ends of the rotating shaft, and the rotating washers are abutted against the rotor plate; the rotating shaft is detachably provided with a fixing pin on the circumferential side of the rotating washers, and the fixing frame is provided with a fixing port relative to the rotating shaft and the fixing pin, and the rotating shaft and the fixing pin can be accommodated in the fixing port, so that the fixing frame can drive the rotating shaft to rotate through the fixing pin.

In the rotor engine, the end cover is further provided with two crescent grooves on a side wall where the accommodating space is recessed, and the two crescent grooves are arranged opposite to each other in the width direction of the guide ring.

In the rotor engine, a sealing strip is provided on the outer peripheral wall of the rotor vanes, the sealing strip extends along the axial direction of the rotating shaft, and the sealing strip seals against the inner peripheral wall of the rotor working space.

In the rotor engine, a side wall of the two rotor plates facing each other is concavely provided with a shaft limiting groove on the circumferential side of the shaft, and the shaft includes a sealing portion and output portions arranged at both axial ends of the sealing portion, the two ends of the sealing portion are accommodated in the shaft limiting groove, the outer peripheral seal of the sealing portion is abutted against the inner side surface of the rotor vanes, and the output portion passes through the adjacent rotor plates and is connected to the link mechanism.

In the rotor engine, the inner wall of the rotor vanes extends in an arc shape relative to the rotating shaft so that the circumferential side wall of the sealing portion fits against the inner wall of the rotor vanes; the outer wall of the rotor vanes extends in an arc shape relative to the inner circumferential side wall of the rotor working space so that the outer wall of the rotor vanes can fit against the inner circumferential wall of the rotor working space.

In the rotor engine, the semi-rotor includes the rotor plate and two rotor vanes, and the angle between the two rotor vanes is 180°.

In the rotor engine, the cylinder body is provided with an air inlet port, an ignition port and an exhaust port on the inner circumferential wall of the rotor working space, the air inlet port is used for external fuel to enter the working chamber; the ignition port is used to ignite the fuel entering the working chamber; the exhaust port is used to discharge the exhaust gas after combustion; in the rotation direction of the rotor, the ignition port, the exhaust port and the air inlet port are arranged in sequence on the inner circumferential wall of the cylinder body.

In the rotor engine, the air inlet and the exhaust port are arranged adjacent to each other on the same side of the cylinder body; the ignition port and the air inlet are respectively arranged on opposite sides of the cylinder body.

In the rotor engine, the outer side wall of the rotor plate is parallel to the end surface of the cylinder along the axial direction of the rotating shaft.

In the rotor engine, in the radial direction of the rotating shaft, the circumferential dimension of the rotor vanes gradually increases; in the circumferential direction of the rotating shaft, an angle is formed between the two side walls of the rotor vanes.

### Beneficial Effects

Compared with the prior art, during the working process of the rotor engine provided by the present application, the working chamber sequentially undergoes intake, compression, working and exhaust strokes, so that multiple working chambers sequentially and uninterruptedly perform power strokes, so that the rotor engine of the present application can continuously provide mechanical kinetic energy to the outside world through the rotating shaft. During the working process of the working chamber, both halves of the rotor rotate around the rotating shaft. During the rotation of the two halves of the rotor, the inner wall of the rotor vanes abuts against the outer peripheral wall of the rotating shaft, and the outer wall of the rotor vanes abuts against the inner peripheral wall of the rotor working space, so that during the rotation of the rotor vanes, the contact type between the rotor vanes and the rotating shaft and the cylinder body is surface contact, which effectively reduces the wear between the rotor and the cylinder body, improves the sealing between the rotor and the cylinder body, and can effectively prevent the fuel in the working chamber from leaking to the outside.

### BRIEF DESCRIPTION OF THE DRAWINGS

FIG. 1 is a schematic structural diagram of a rotor engine according to the present application.

FIG. 2 is a schematic structural diagram of the structure shown in FIG. 1 from another viewing angle.

FIG. 3 is an exploded schematic diagram of the structure shown in FIG. 1.

FIG. 4 is a partially exploded schematic diagram of the cylinder body, rotor and link mechanism of the rotor engine of the present application.

FIG. 5 is a schematic diagram showing the separation of the cylinder body and the rotor of the rotor engine of the present application.

FIG. 6 is a schematic structural diagram of a cylinder body of a rotor engine according to the present application.

FIG. 7 is an axial view of the cylinder of the rotor engine of the present application viewed along the axial direction of the rotor working space.

FIG. 8 is a schematic diagram of the structural decomposition of the rotor of the rotor engine of the present application.

FIG. 9 is a schematic diagram of the combined structure of the two semi-rotors of the rotor engine of the present application.

FIG. 10 is a schematic diagram of the rotor of the rotor engine of the present application when it is in the first working state.

FIG. 11 is a schematic diagram of the rotor of the rotor engine of the present application when it is in the second working state.

FIG. 12 is a schematic diagram of the rotor of the rotor engine of the present application when it is in the third working state.

FIG. 13 is a schematic diagram of the rotor of the rotor engine of the present application when it is in the fourth working state.

FIG. 14 is a schematic diagram of the rotor of the rotor engine of the present application when it is in the fifth working state.

FIG. 15 is a schematic diagram of the rotor of the rotor engine of the present application when it is in the sixth working state.

FIG. 16 is a schematic diagram of the rotor of the rotor engine of the present application when it is in the seventh working state.

FIG. 17 is a schematic diagram of the rotor of the rotor engine of the present application when it is in the eighth working state.

FIG. 18 is a schematic structural diagram of the link mechanism of the rotor engine of the present application.

FIG. 19 is a schematic diagram of the structure of the end cover of the rotor engine of the present application.

FIG. 20 is an axial schematic diagram of the structure shown in FIG. 19 viewed along the axial direction of the rotating shaft.

FIG. 21 is a schematic diagram of the projection of the guide ring of the rotor engine of the present application in a plane perpendicular to the axis of the rotating shaft.

FIG. 22 is a schematic diagram of one operating state of the link mechanism and the guide ring of the rotor engine of the present application.

FIG. 23 is a schematic diagram of the projection of another guide ring of the rotor engine of the present application in a plane perpendicular to the axis of the shaft.

FIG. 24 is a schematic diagram of the link mechanism of the rotor engine of the present application when it is in the first working state.

FIG. 25 is a schematic diagram of the link mechanism of the rotor engine of the present application when it is in the second working state.

FIG. 26 is a schematic diagram of the link mechanism of the rotor engine of the present application when it is in the third working state.

FIG. 27 is a schematic diagram of the link mechanism of the rotor engine of the present application when the rotor engine is in the fourth working state.

FIG. 28 is a schematic diagram of the link mechanism of the rotor engine of the present application when the rotor engine is in the fifth working state.

FIG. 29 is a schematic diagram of the link mechanism of the rotor engine of the present application when the rotor engine is in the sixth working state.

FIG. 30 is a schematic diagram of the link mechanism of the rotor engine of the present application when it is in the seventh working state.

FIG. 31 is a schematic diagram of the link mechanism of the rotor engine of the present application when the rotor engine is in the eighth working state.

### DETAILED DESCRIPTION OF THE PREFERRED EMBODIMENTS

The present application provides a rotor engine. To make the purpose, technical solution and effect of the present application clearer and more specific, the present application is further described in detail with reference to the accompanying drawings and examples. It should be understood that the specific embodiments described herein are only used to explain the present application and are not used to limit the present application.

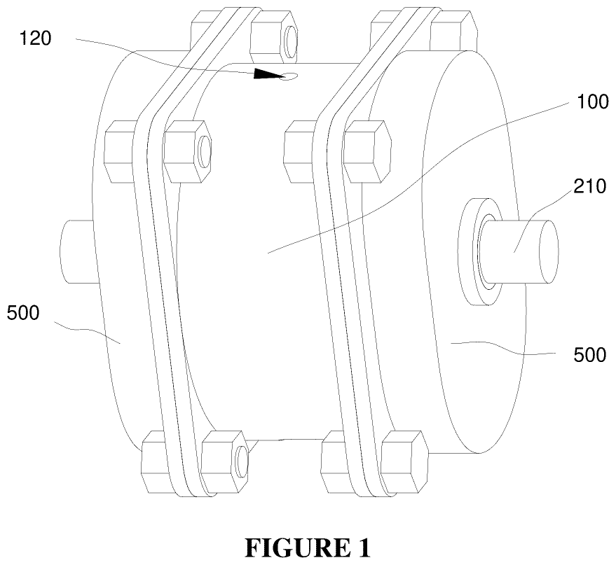

FIG. 1 is a schematic structural diagram of a rotor engine according to the present application.

Referring to FIG. 1, for the convenience of reference and understanding, the rotor engine is placed horizontally as a reference, and the rotary shaft of the rotor engine extends in the horizontal direction.

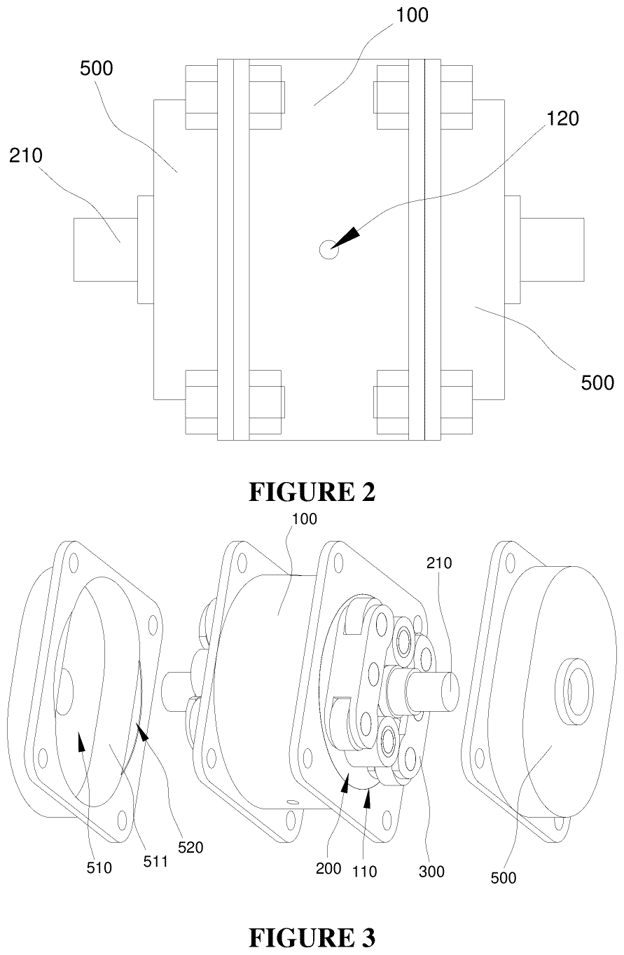

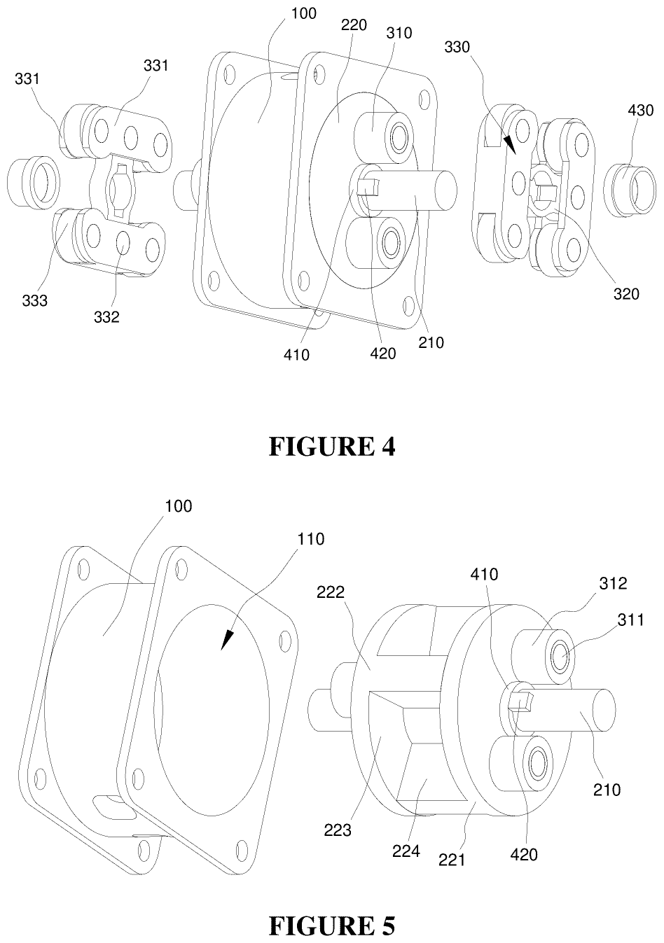

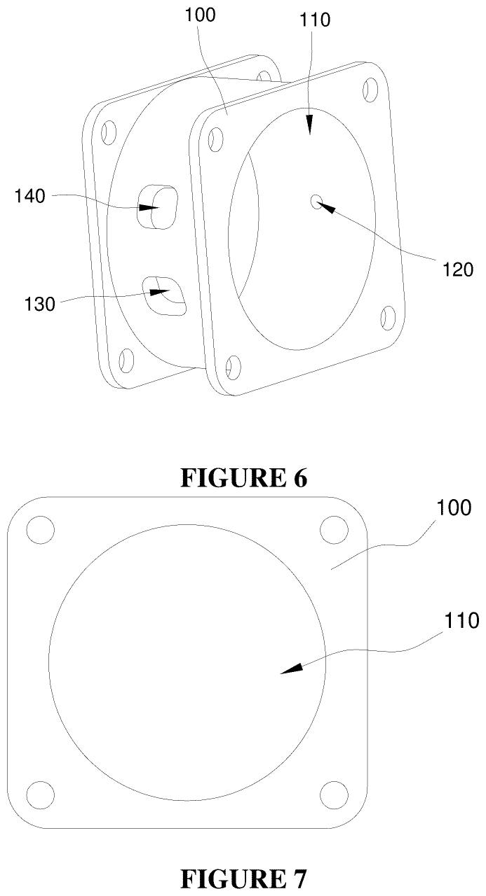

FIG. 2 is a schematic diagram of the structure shown in FIG. 1 from another perspective. FIG. 3 is an exploded schematic diagram of the structure shown in FIG. 1. FIG. 4 is a partially exploded schematic diagram of the cylinder body, rotor and link mechanism of the rotor engine of the present application. FIG. 5 is a schematic diagram of the separation of the cylinder body and rotor of the rotor engine of the present application. FIG. 6 is a schematic diagram of the structure of the cylinder body of the rotor engine of the present application.

Referring to FIGS. 1 to 6, the present application provides a rotor 200 engine, which includes: a cylinder body 100, a rotor 200 and two link mechanisms 300. A circular working space 110 is provided in the cylinder body 100. The rotor 200 is arranged in the rotor working space 110, and the rotor 200 includes a rotating shaft 210 and two oppositely arranged semi-rotors 220, and the rotating shaft 210 extends along the axis of the rotor working space 110. The semi-rotor 220 includes a rotor plate 223 and a plurality of rotor vanes 224 arranged on the rotor plate 223, and the two rotor plates 223 are arranged on the rotating shaft 210 at intervals, and the outer peripheral wall of the rotor plate 223 abuts against the inner peripheral wall of the rotor working space 110. The multiple rotor vanes 224 on a rotor plate 223 all extend along the axial direction of the rotating shaft 210 to seal against another rotor plate 223. The angles between any two adjacent rotor vanes 224 on the same rotor plate 223 are equal. The inner and outer side walls of the rotor vanes 224 respectively seal against the outer peripheral wall of the rotating shaft 210 and the inner peripheral wall of the rotor working space 110. The inner peripheral wall of the rotor working space 110, the two adjacent rotor vanes 224, the two rotor plates 223 and the rotating shaft 210 together form a working chamber for combustion and work. two link mechanisms 300 are separately arranged on the outer side of the rotor 200. The link mechanisms 300 are connected to the rotating shaft 210 and the adjacent rotor plates 223. The rotation of one half of the rotor 220 can drive the rotating shaft 210 to rotate through the link mechanism 300. The rotating shaft 210 can drive the other half of the rotor 220 to rotate through the other link mechanism 300, so that there is an angle between any two adjacent rotor vanes 224.

During the operation of the rotor 200 engine, During the operation of the rotor 200 engine, the inner and outer side walls of multiple rotor vanes 224 respectively seal and support the outer peripheral wall of the rotating shaft 210 and the inner peripheral wall of the working space 110. As a result, the contact between the rotor vanes 224 and both the rotating shaft 210 and the cylinder body is surface contact. Furthermore, as the rotor vanes 224 rotate around the shaft 210, the angles between each vane and the outer peripheral wall of the shaft 210, as well as between each vane and the inner peripheral wall of the working space 110, remain constant. This ensures that the contact between the rotor vanes 224 and both the rotating shaft 210 and the working space 110 consistently remains surface contact, thereby effectively maintaining the sealing performance of the working chamber and enhancing the fuel combustion efficiency.

When the rotor 200 engine burns and works, the fuel enters the multiple working chambers in sequence. When the multiple working chambers work in sequence, the rotor vanes 224 of the working chamber drives the rotor plate 223 connected to it to rotate under the action of kinetic energy, and the rotor plate 223 drives the phase roller 310 to rotate synchronously. During the rotation process, the phase roller 310 drives the rotating shaft 210 to rotate through a link mechanism 300, and the rotating shaft 210 drives another link mechanism 300 to rotate through the rotating shaft 210. There is an angle between any two adjacent rotor vanes 224 to prevent one half of the rotor 220 from rotating clockwise after receiving kinetic energy, while the other half of the rotor 220 rotates counterclockwise due to kinetic energy. It can prevent the rotor vanes 224 on one half of the rotor 220 from colliding with the rotor vanes 224 of the other half of the rotor 220, thereby damaging the rotor 200 engine. The link mechanism 300 can also drive the other half of the rotor 220 to rotate clockwise when one half of the rotor 220 rotates clockwise, thereby fully utilizing the kinetic energy generated by the combustion of the fuel.

FIG. 7 is an axial view of the cylinder of the rotor engine of the present application viewed along the axial direction of the rotor working space.

Referring to FIGS. 6 and 7, in this embodiment, a circular working space 110 is provided in the cylinder body 100, and the axis of the rotor working space 110 extends horizontally. The cylinder body 100 is also provided with an air inlet 140, an ignition port 120 and an exhaust port 130 on the inner peripheral wall of the rotor working space 110. The air inlet 140 is used for external fuel to enter the working chamber. The ignition port 120 is used to ignite the fuel entering the working chamber. The exhaust port 130 is used to discharge the exhaust gas after combustion and work.

The ignition port 120 is arranged on one side of the cylinder body 100, and the air inlet port 140 and the exhaust port 130 are arranged adjacent to each other, and the air inlet port 140 and the exhaust port 130 are arranged on the other side of the cylinder body 100. In the rotation direction of the rotor 200, the ignition port 120, the exhaust port 130, and the air inlet port 140 are arranged in sequence on the inner circumferential wall of the cylinder body 100. After receiving the fuel input from the air inlet port 140, the working chamber ignites and performs work through the ignition port 120, and finally the exhaust gas generated after the fuel is burned is discharged to the outside through the exhaust port 130, thereby completing the work process of a working chamber of the rotor 200.

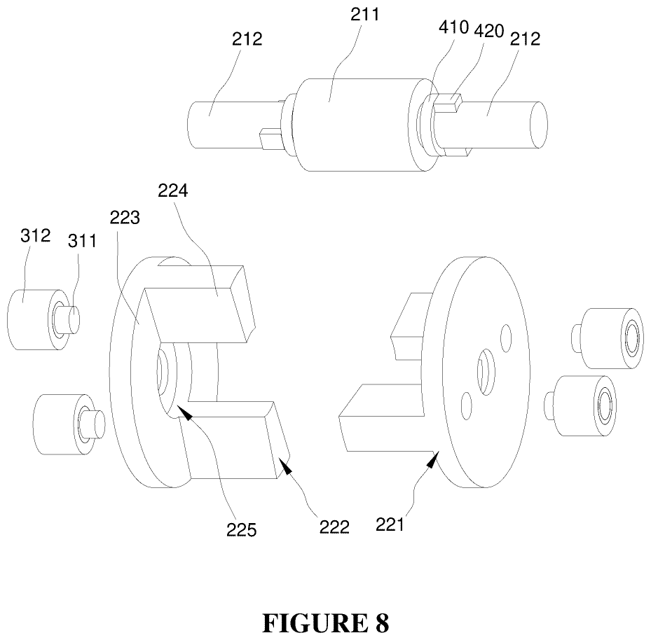

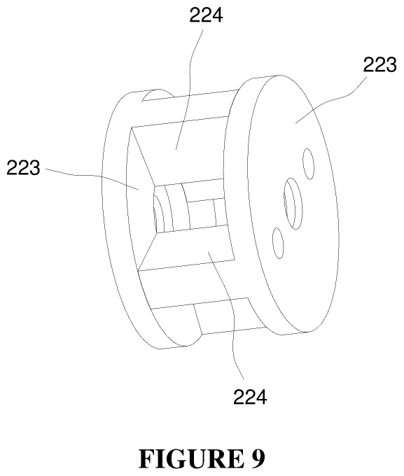

FIG. 8 is a schematic diagram of the structure of the rotor of the rotor engine of the present application. FIG. 9 is a schematic diagram of the structure of the two halves of the rotor of the rotor engine of the present application.

Referring to FIGS. 3, 4, 5, 8 and 9, in this embodiment, the rotor 200 includes a shaft 210 and two semi-rotors 220. The shaft 210 is disposed in the rotor working space 110 and extends in the axial direction of the rotor working space 110. The shaft 210 includes a scaling portion 211 and output portions 212 disposed at both axial ends of the sealing portion 211. The scaling portion 211 is located in the two semi-rotors 220, and the sealing portion 211 abuts against one side wall of the rotor plate 223 facing each other. The output portion 212 passes through the rotor plate 223 to be connected to the link mechanism 300. On the one hand, the sealing performance between the shaft 210 and the semi-rotor 220 can be improved to prevent the fuel from leaking to the outside during the compression and working process, thereby damaging the rotor 200 engine and reducing the service life of the rotor 200 engine. On the other hand, when the rotating shaft 210 and the semi-rotor 220 move relative to each other, the transmission connection among the rotating shaft 210, the link mechanism 300 and the semi-rotor 220 can be realized, thereby driving the two semi-rotors 220 to move in the same direction, realizing the working process of the present technical solution.

In some embodiments, the sealing portion 211 is coaxially arranged with the output portion 212, and the radius of the sealing portion 211 is smaller than the radius of the output portion 212, so that after the rotating shaft 210 is sealed and connected to the two semi-rotors 220, the circumferential side wall of the sealing portion 211 constitutes the side wall of the working chamber, thereby improving the structural strength of the rotating shaft 210 in the working chamber and improving the bearing capacity of the rotating shaft 210.

In some embodiments, an output portion 212 of the rotating shaft 210 may be in driving connection with a driving device (not shown) so that the driving device can provide initial power to the rotor 200. In other embodiments, both output portions 212 of the rotating shaft 210 can output kinetic energy.

Referring to FIGS. 3 to 5, 8 and 9, in this embodiment, the semi-rotor 220 is accommodated in the rotor working space 110, and the two semi-rotors 220 are arranged opposite to each other. The semi-rotor 220 includes a rotor plate 223 and two rotor vanes 224, and the rotor plate 223 extends in a plane perpendicular to the axial direction of the rotor 200, and the outer peripheral wall of the rotor plate 223 abuts against the inner peripheral wall of the rotor working space 110.

A shaft limiting groove 225 is concavely formed on one side wall of the two rotor plates 223 facing each other, and the shaft limiting groove 225 is used to accommodate the sealing portion 211 of the shaft 210. The inner peripheral wall of the shaft limiting groove 225 abuts against the peripheral side wall of the sealing portion 211 of the shaft 210, and the bottom wall of the shaft limiting groove 225 abuts against the end surface of the sealing portion 211. The output portion 212 passes through the bottom wall of the shaft limiting groove 225 and is connected to the link mechanism 300.

In some embodiments, the outer wall of the rotor plate 223 is parallel to the end surface of the cylinder along the axial direction of the rotating shaft 210, so that the rotor 200 engine structure is compact and the movement of the link mechanism 300 is convenient. In other embodiments, the outer wall of the rotor plate 223 is opened relative to the two rotor vanes 224 thereon for fixed connection with the phase roller 310. The rotor vanes 224 is arranged on one side wall of the two rotor plates 223 facing each other. the rotor vanes 224 extends along the axial direction of the rotating shaft 210. the rotor vanes 224 on one rotor plate 223 is scaled against the other rotor plate 223. The two rotor vanes 224 in the same semi-rotor 220 are symmetrically arranged relative to the rotating shaft 210. the rotor vanes 224 on the two semi-rotors 220 are staggered, and an angle is formed between any two adjacent rotor vanes 224. The two semi-rotors 220 divide the rotor working space 110 in the cylinder into four working chambers. The four working chambers of the rotor 200 engine can complete the four strokes of intake, compression, working, and exhaust in sequence, and can realize the four working chambers of the rotor 200 engine to carry out the working process in sequence without interruption, thereby improving the speed and working efficiency of the rotor 200 engine. The outer wall of the rotor vanes 224 is sealed against the inner wall of the rotor working space 110, and the side wall of the rotor vanes 224 is sealed against the outer wall of the sealing part 211, so that during the rotation of the rotor vanes 224 and the rotation of the shaft 210, the rotor vanes 224 is sealed against the inner wall of the rotor working space 110 and the outer wall of the shaft 210, thereby improving the sealing performance of the rotor 200 engine working chamber during the work process.

In some embodiments, the inner circumferential wall of the rotor vanes 224 against the outer circumferential wall of the rotating shaft 210 is arc-shaped to fit the rotating shaft 210, thereby improving the sealing performance between the rotor vanes 224 and the rotating shaft 210. The outer side wall of the rotor vanes 224 is arc-shaped to fit the inner circumferential wall of the rotor working space 110, so as to seal the gap between the rotor vanes 224 and the inner circumferential wall of the rotor working space 110. In other embodiments, a sealing strip (not shown in the figure) is provided on the outer circumferential wall of the rotor vanes 224, and the sealing strip extends along the axial direction of the rotating shaft 210. The sealing strip seals against the inner circumferential wall of the rotor working space 110 to further improve the sealing performance between the rotor vanes 224 and the inner circumferential wall of the rotor working space 110. In other embodiments, there are multiple sealing strips, and the multiple sealing strips are arranged at intervals along the circumferential direction of the rotating shaft 210 to improve the scaling performance between the rotor vanes 224 and the inner circumferential wall of the rotor working space 110. In other embodiments, the sealing strip covers the outer circumferential wall of the rotor vanes 224.

Referring to FIGS. 5, 8 and 9, in this embodiment, in the radial direction of the rotating shaft 210, the circumferential dimensions of the rotor vanes 224 gradually increase. In the circumferential direction of the rotating shaft 210, there is an angle between the two circumferential side walls of the rotor vanes 224. This enables the kinetic energy generated by the combustion of fuel to impact the circumferential side walls of the rotor vanes 224 when the working chamber composed of any two adjacent rotor vanes 224 is working, so that the direction of the kinetic energy borne by the rotor vanes 224 is tangent to the circumferential rotation trajectory of the rotor vanes 224, thereby improving the utilization efficiency of the fuel during combustion.

In some embodiments, the angle between the two outer walls on the rotor vanes 224 is greater than the angle between the ignition port 120, the exhaust port 130 and the air inlet port 140, so that the rotor vanes 224 can resist and seal the ignition port 120, the exhaust port 130 and the air inlet port 140 during rotation, so as to realize the working process of the working chamber and improve the air tightness of the working chamber.

The two halves of the rotor 220, the rotating shaft 210 and the cylinder body form four working chambers, and the four working chambers can all be in the power strokes of intake, compression, working and exhaust, and at the same time, the four working chambers are respectively in the power strokes of intake, compression, working and exhaust, so that the rotor 200 engine can continue to run.

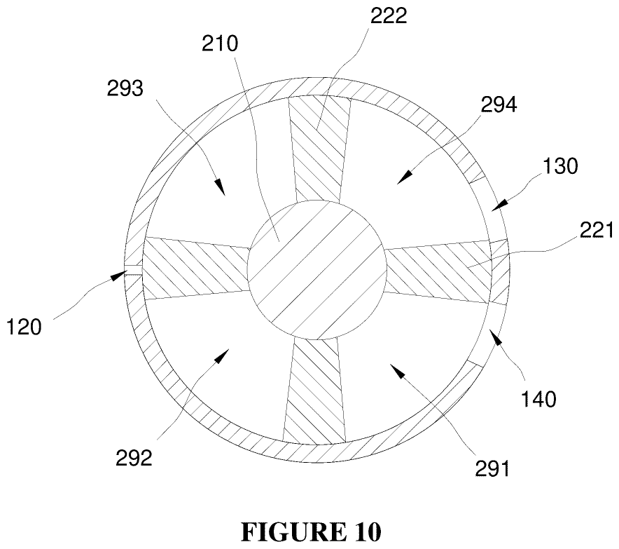

FIG. 10 is a schematic diagram of the rotor of the rotor engine of the present application when it is in the first working state.

Referring to FIGS. 5, 9 and 10, the two semi-rotors 220 include a first semi-rotor 221 and a second semi-rotor 222, and the working chambers include a first working chamber 291, a second working chamber 292, a third working chamber 293 and a fourth working chamber 294.

Referring to FIG. 10, when the rotor 200 is in the first working state, one rotor vanes 224 of the first semi-rotor 221 abuts against the sealed ignition port 120, and the other rotor vanes 224 of the first semi-rotor 221 abuts against the side wall between the intake port 140 and the exhaust port 130, and the rotor vanes 224 of the two semi-rotors 220 are perpendicular to each other. At this time, the first working chamber 291 performs an intake stroke, the second working chamber 292 performs a compression stroke, the third working chamber 293 performs a power stroke after being ignited through the ignition port 120, and the fourth working chamber 294 performs an exhaust stroke through the exhaust port 130. The verticality in this article is only a textual description, and factors such as processing errors should be considered in practice.

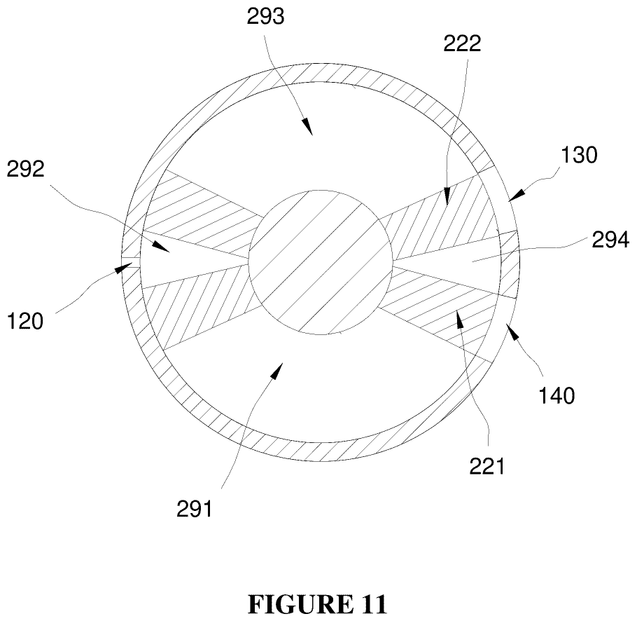

FIG. 11 is a schematic diagram of the rotor of the rotor engine of the present application when it is in the second working state.

Referring to FIGS. 10 and 11, when the first semi-rotor 221 and the second semi-rotor 222 rotate clockwise in the first working state, the second working state is obtained. At this time, the first semi-rotor 221 abuts against and seals the intake port 140, the second semi-rotor 222 abuts against and seals the exhaust port 130, and the ignition port 120 is aligned with the second working chamber 292. After the first working chamber 291 is in the intake stroke, the compression stroke begins; after the second working chamber 292 is in the compression stroke, the power stroke begins; after the third working chamber 293 is in the combustion stroke, the exhaust stroke begins; after the fourth working chamber 294 is in the exhaust stroke, the intake stroke begins.

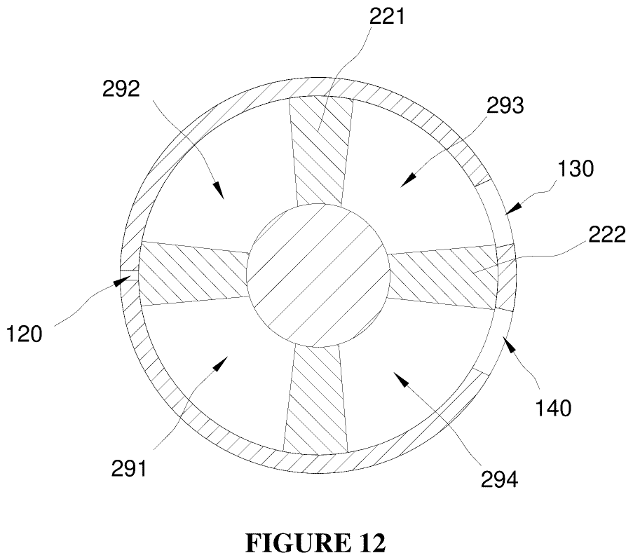

FIG. 12 is a schematic diagram of the rotor of the rotor engine of the present application when it is in the third working state.

Referring to FIGS. 11 and 12, when the first semi-rotor 221 and the second semi-rotor 222 rotate clockwise in the second working state, the third working state is obtained. One rotor vanes 224 of the second semi-rotor 222 abuts against the sealed ignition port 120, and another rotor vanes 224 of the second semi-rotor 222 abuts against the side wall between the intake port 140 and the exhaust port 130, and the rotor vanes 224 of the two semi-rotors 220 are perpendicular to each other. At this time, the first working chamber 291 performs a compression stroke, the second working chamber 292 performs a power stroke, the third working chamber 293 performs an exhaust stroke, and the fourth working chamber 294 performs an intake stroke.

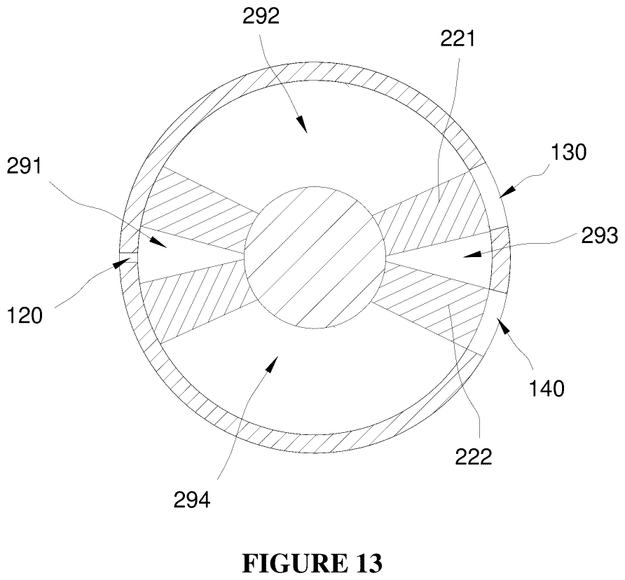

FIG. 13 is a schematic diagram of the rotor of the rotor engine of the present application when it is in the fourth working state.

Referring to FIGS. 12 and 13, when the first semi-rotor 221 and the second semi-rotor 222 rotate clockwise in the third working state, the fourth working state is obtained. At this time, the first semi-rotor 221 abuts against and seals the exhaust port 130, the second semi-rotor 222 abuts against and seals the intake port 140, and the ignition port 120 is aligned with the first working chamber 291 and can ignite the first working chamber 291. After the first working chamber 291 is in the compression stroke, the power stroke begins; after the second working chamber 292 is in the power stroke, the exhaust stroke begins, after the third working chamber 293 is in the exhaust stroke, the intake stroke begins. After the intake is completed, the fourth working chamber 294 begins the compression stroke.

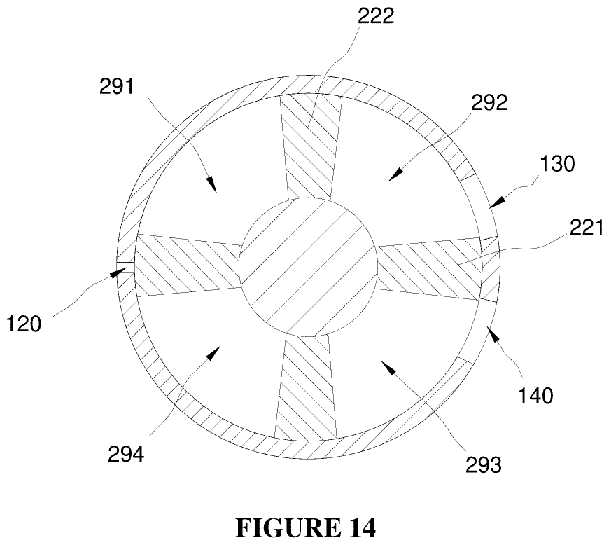

FIG. 14 is a schematic diagram of the rotor of the rotor engine of the present application when it is in the fifth working state.

Referring to FIGS. 13 and 14, when the first semi-rotor 221 and the second semi-rotor 222 rotate clockwise in the fourth working state, the fifth working state is obtained. One rotor vanes 224 of the first semi-rotor 221 abuts against the side wall between the exhaust port 130 and the intake port 140, and another rotor vanes 224 of the first semi-rotor 221 seals against the ignition port 120, and the rotor vanes 224 of the two semi-rotors 220 are perpendicular to each other. At this time, the first working chamber 291 is in the power stroke, the second working chamber 292 is in the exhaust stroke, the third working chamber 293 is in the intake stroke, and the fourth working chamber 294 is in the compression stroke.

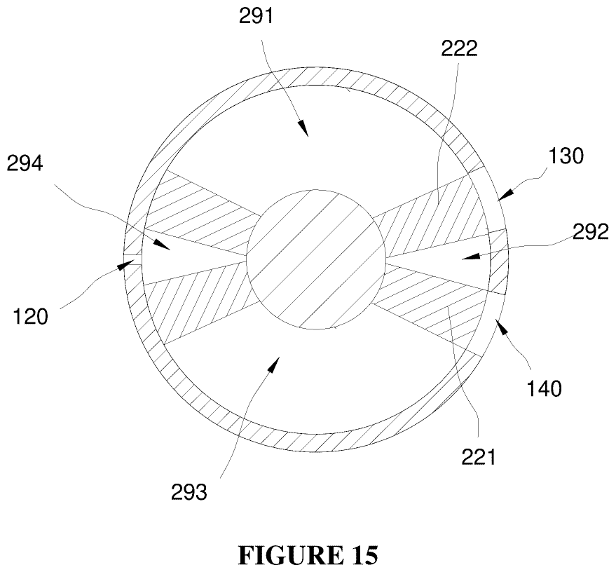

FIG. 15 is a schematic diagram of the rotor of the rotor engine of the present application when it is in the sixth working state.

Referring to FIGS. 14 and 15, when the first semi-rotor 221 and the second semi-rotor 222 rotate clockwise in the fifth working state, the sixth working state is obtained. The rotor vanes 224 of the first semi-rotor 221 seals against the air inlet port 140, and the rotor vanes 224 of the second semi-rotor 222 seals against the exhaust port 130. At this time, the first working chamber 291 is in the state of combustion completion and starts the exhaust stroke; the second working chamber 292 is in the state of exhaust completion and starts the intake stroke; the third working chamber 293 is in the state of intake completion and starts the compression stroke; the fourth working chamber 294 is in the state of compression completion and starts the power stroke.

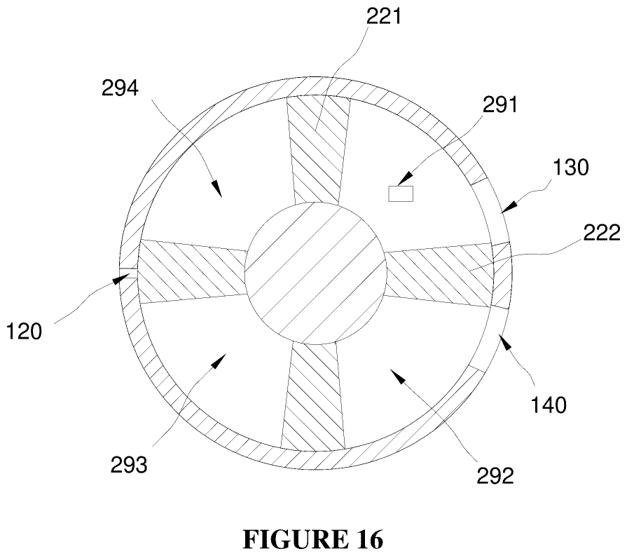

FIG. 16 is a schematic diagram of the rotor of the rotor engine of the present application when it is in the seventh working state.

Referring to FIGS. 15 and 16, when the first semi-rotor 221 and the second semi-rotor 222 rotate clockwise in the sixth working state, the seventh working state is obtained. One rotor vanes 224 of the second semi-rotor 222 abuts against the side wall between the exhaust port 130 and the intake port 140, and another rotor vanes 224 of the second semi-rotor 222 seals against the ignition port 120, and the rotor vanes 224 of the two semi-rotors 220 are perpendicular to each other. At this time, the first working chamber 291 is in the exhaust stroke, the second working chamber 292 is in the intake stroke, the third working chamber 293 is in the compression stroke, and the fourth working chamber 294 is in the power stroke.

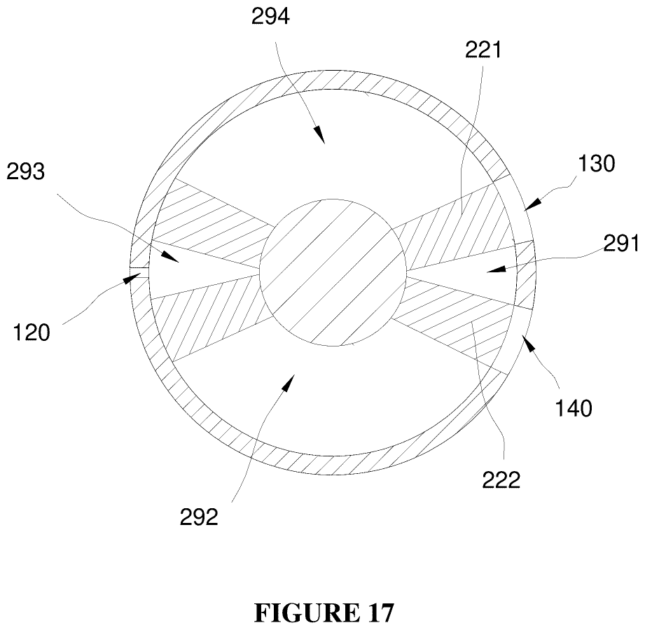

FIG. 17 is a schematic diagram of the rotor of the rotor engine of the present application when it is in the eighth working state.

Referring to FIGS. 16 and 17, when the first semi-rotor 221 and the second semi-rotor 222 rotate clockwise in the seventh working state, the eighth working state is obtained. The rotor vanes 224 of the first semi-rotor 221 seals against the exhaust port 130, and the rotor vanes 224 of the second semi-rotor 222 seals against the intake port 140, and the ignition port 120 is aligned with the third working chamber 293. At this time, the first working chamber 291 is in the exhaust stroke after the exhaust stroke is completed, and the intake stroke begins; the second working chamber 292 is in the intake stroke after the intake stroke is completed, and the compression stroke begins; the third working chamber 293 is in the compression stroke after the compression stroke is completed, and the power stroke begins; the fourth working chamber 294 is in the power stroke after the exhaust stroke is completed.

Referring to FIGS. 17 and 10, when the rotor 200 is in the eighth working state, the rotor 200 continues to rotate clockwise under the action of the kinetic energy of fuel combustion to rotate to the first working state. At this time, the first working state to the eighth working state are circulated in sequence to achieve uninterrupted work of the four working chambers, thereby improving the working efficiency of the rotor 200 engine.

Referring to FIGS. 11, 13, 15 and 17, in this embodiment, the angle between the center lines of two adjacent rotor vanes 224 along the radial direction is greater than 39.45°, so that when the rotor 200 is in the second working state, the fourth working state, the sixth working state and the eighth working state, the angle between the two adjacent rotor vanes 224 is the smallest, so that the angle between the two adjacent rotor vanes 224 is 39.45°.

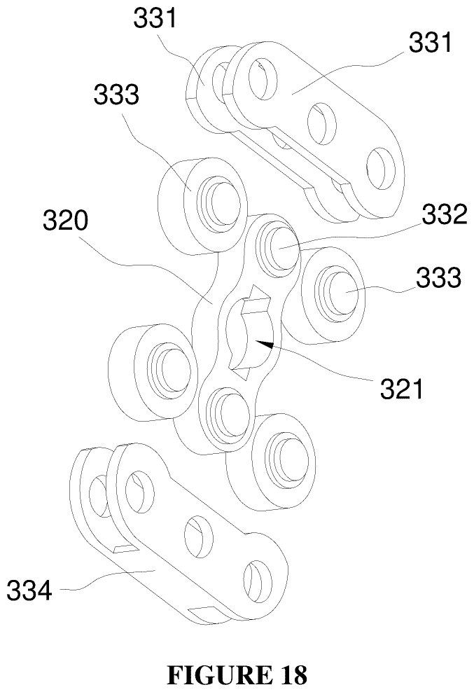

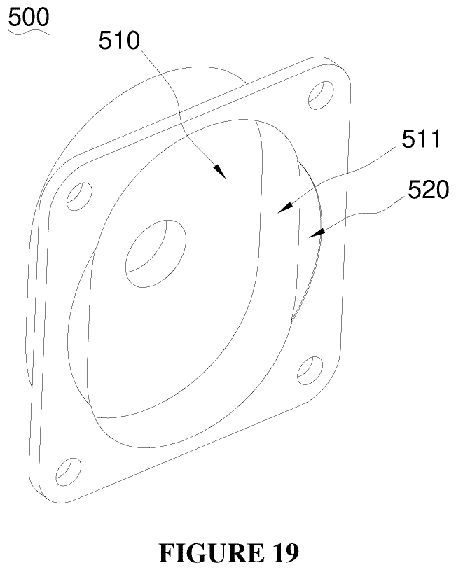

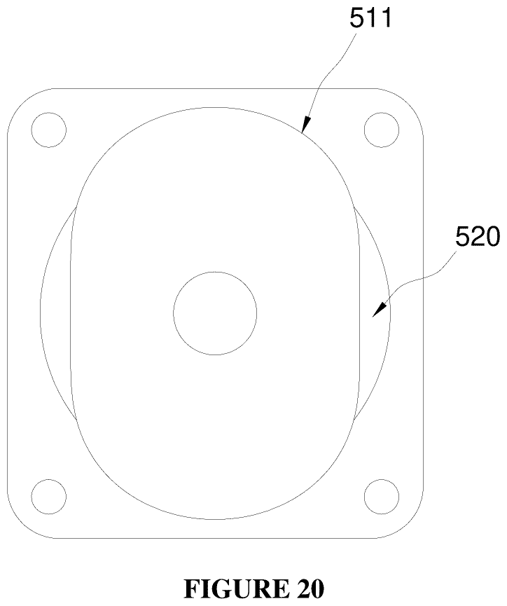

FIG. 18 is a schematic diagram of the structure of the link mechanism of the rotor engine of the present application. FIG. 19 is a schematic diagram of the structure of the end cover of the rotor engine of the present application. FIG. 20 is an axial schematic diagram of the structure shown in FIG. 19 viewed along the axial direction of the rotating shaft.

Referring to FIGS. 2, 3, 18 to 20, in this embodiment, the rotor 200 engine further comprises two end covers 500, which are detachably covered on the two ends of the cylinder body 100, and a receiving space 510 is recessed on one side of the end cover 500 facing the link mechanism 300, and the inner peripheral wall of the receiving space 510 encloses a guide ring 511. The two link mechanisms 300 are arranged at the two ends of the rotating shaft 210, and the link mechanism 300 is located between the rotor 200 and the end cover 500, and is accommodated in the receiving space 510.

During the movement of the link mechanism 300, it abuts against the guide ring 511. The link mechanism 300 moves along the guide ring 511 to realize the same-direction rotation of the two semi-rotors 220, thereby ensuring that there is an angle between two adjacent rotor vanes 224.

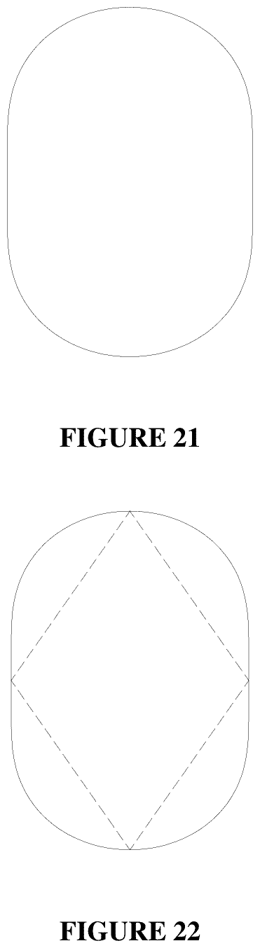

FIG. 21 is a schematic diagram of the projection of the guide ring of the rotor engine of the present application in a plane perpendicular to the axis of the rotating shaft.

Referring to FIG. 21, in this embodiment, on a plane perpendicular to the rotating shaft, with the axis of the rotating shaft 210 as the origin, the projection line of the guide ring 511 satisfies the following trajectory formula: ρ=d*cos(π/4+f(cos(2*θ))), where d is the size parameter of the side of the rhombus, θ is the angle between the positive direction of the polar axis and the ray from the polar origin to the center of the roller on the movable part, cos( ) is a cosine function, and f( ) is an odd function and is second-order differentiable.

The equation determines a smooth closed curve with a period of x, and any point on the curve is a vertex of an inscribed rhombus, and can move on the smooth closed curve. The vertex angle of the inscribed rhombus changes periodically while the side length of the rhombus remains unchanged. The linkage mechanism 300 of the present application is formed according to the rhombus structure of the equation, and the running trajectory of the linkage mechanism 300 is like the above-mentioned smooth closed curve. The linkage mechanism 300 abuts and extends according to the guide ring 511, so that there is an angle between the two adjacent rotor vanes 224, and the two semi-rotors 220 can rotate synchronously.

FIG. 22 is a schematic diagram of one operating state of the link mechanism and the guide ring of the rotor engine of the present application.

Referring to FIGS. 21 and 22, in some embodiments, an appropriate generatrix equation is selected based on factors such as the required compression ratio of the rotor 200 engine and the size of the rotor 200. For convenience of understanding, the generatrix equation of the guide ring 511 selected in this embodiment is: ρ=d*cos(π/4+0.3*atan(cos(2*θ))), wherein d is the size parameter of the side of the rhombus, and θ is the angle between the positive direction of the polar axis and the ray from the polar origin to the center of the roller on the movable part.

The working and structural principle of the variable-angle rotor engine demands that, during rotation, the distance between the centers of adjacent rollers remains constant and equal to *d*; and the angle subtended at the main-shaft center by the centers of adjacent rollers also stays fixed at π/2 (90°). Thus the four roller centers form the vertices of a variable-angle rhombus whose side length is always *d*; equivalently, the polar equation ρ(θ) of the roller centers must satisfy ρ(θ)²+ρ(θ+π/2)²=d². The general solution ρ(θ)=d*cos (π/4+f (cos(2θ)))) is obtained, where f is a continuous and smooth odd function.

The following verification general solution meets the requirements.

$$ρ ( θ + π / 2 ) = d \cdot cos [ π / 4 + f ( cos ( 2 ( θ + π / 2 ) ) ) ] = d \cdot cos [ π / 4 + f ( cos ( 2 θ + π ) ) ] = d \cdot cos [ π / 4 + f ( - cos 2 θ ) ] = d \cdot cos [ π / 4 - f ( cos 2 θ ) ] = d \cdot sin [ π / 2 - ( π / 4 - f ( cos 2 θ ) ) ] = d \cdot sin [ π / 4 + f ( cos 2 θ ) ] .$$

$$Obviously , {ρ ( θ )}^{2} + {ρ ( θ + π / 2 )}^{2} = {d}^{2} {cos}^{2} [ π / 4 + f ( cos 2 θ ) ] + {d}^{2} {sin}^{2} [ π / 4 + f ( cos 2 θ ) ] = {d}^{2} .$$

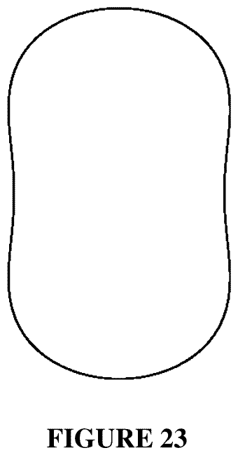

FIG. 23 is a schematic diagram of the projection of another guide ring of the rotor engine of the present application in a plane perpendicular to the axis of the shaft.

Referring to FIGS. 21 and 23, in some other embodiments, the projection line of the guide ring 511 satisfies the following trajectory formula: ρ=d*cos(π/4+0.36*atan (cos(2*θ))), where d is the size parameter of the side of the rhombus and θ is the angle between the positive direction of the polar axis and the ray from the polar origin to the center of the roller on the movable part.

In some embodiments, the end cover 500 is detachably connected to the cylinder body to facilitate the disassembly and maintenance of the rotor 200 engine.

Referring to FIGS. 3, 4 and 18, in this embodiment, the link mechanism 300 includes a phase roller 310, a fixed frame 320 and a movable member 330. The phase roller 310 is connected to the outer wall of the rotor plate 223 to rotate with the rotor plate 223. The fixed frame 320 is fixedly connected to the output portion 212 of the rotating shaft 210 to rotate with the rotating shaft 210, and the movable member 330 is rotatably connected to the fixed frame 320. The phase roller 310 revolves around the rotating shaft 210, and the movable member 330 moves to drive the fixed frame 320 and the rotating shaft 210 to rotate.

When the first semi-rotor 221 rotates, the first semi-rotor 221 drives the phase roller 310 thereon to rotate around the rotating shaft 210. The phase roller 310 rotates to abut and squeeze the movable member 330. The movable member 330 can abut the guide ring 511 and move along the guide ring 511 under the squeezing force. During the movement of the movable member 330, the fixed frame 320 drives the rotation of the axis of the rotating shaft 210. During the rotation of the fixed frame 320, the output part 212 is driven to rotate synchronously around the axis of the rotating shaft 210. When the rotating shaft 210 rotates, another link mechanism 300 on another output part 212 of the rotating shaft 210 is used to drive the second rotor plate 223 to rotate. Because the two link mechanisms 300 have a certain relative rotation margin during the rotation process, the angle between any two adjacent rotor vanes 224 is between 39.45° and 140.55°. On the one hand, it can prevent the first semi-rotor 221 from rotating clockwise and the second semi-rotor 222 from rotating counterclockwise to resist and hit the rotor vanes 224 of the first semi-rotor 221 under the impact of the kinetic energy of fuel combustion, thereby damaging the rotor 200 engine. On the other hand, it can ensure that the two semi-rotors 220 rotate in the same direction, thereby improving the energy utilization efficiency generated by fuel combustion.

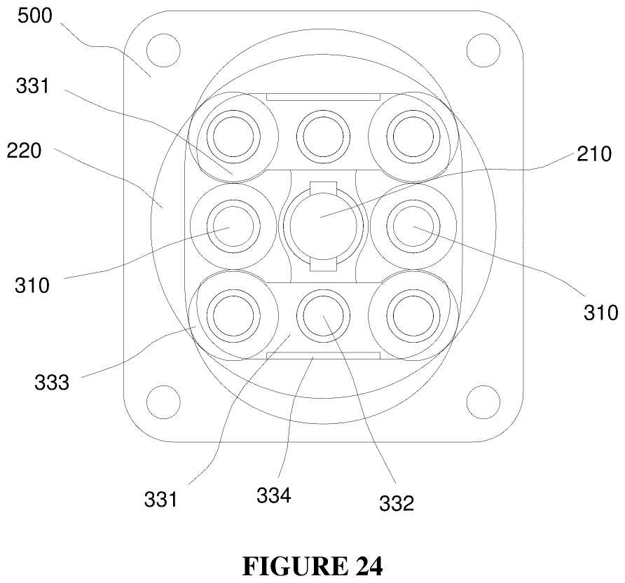

FIG. 24 is a schematic diagram of the link mechanism of the rotor engine of the present application when it is in the first working state.

Referring to FIGS. 3, 4, 18 and 24, in this embodiment, the link mechanism 300 includes two phase rollers 310, a fixed frame 320 and two movable members 330, and the two phase rollers 310 are symmetrically arranged relative to the rotating shaft 210. The fixed frame 320 extends in a direction perpendicular to the arrangement direction of the two phase rollers 310, and the output portion 212 of the rotating shaft 210 is accommodated in the middle of the fixed frame 320. A movable member 330 is rotatably arranged at both ends of the fixed frame 320, and the movable member 330 extends along the arrangement direction of the phase rollers 310. The two movable members 330 in the same link mechanism 300 are symmetrically arranged relative to the rotating shaft 210, and the movable member 330 includes two movable bearings 333 arranged at both ends thereof, and the movable bearings 333 are supported on the guide ring 511. At this time, the two points on the two movable members 330 that are respectively pressed against the guide ring 511 are the four points of the rhombus in the above trajectory equation, so that the link mechanism 300 satisfies the above smooth closed curve.

When the rotor 200 is working, the first semi-rotor 221 rotates clockwise around the rotating shaft 210 to drive the two-phase roller 310 to rotate clockwise around the rotating shaft 210. During the clockwise rotation of the two-phase roller 310, it abuts against the movable member 330 to press the movable bearing 333 of the movable member 330 onto the guide ring 511. During the movement of the movable bearing 333, it can synchronously rotate relative to the fixed frame 320. During the movement of the movable member 330 relative to the fixed frame 320, the movable member 330 can drive the fixed frame 320 to rotate around the rotating shaft 210, thereby driving the rotating shaft 210 to rotate. During the relative rotation of the first semi-rotor 221 and the rotating shaft 210, the second rotor plate 223 is driven to rotate through the rotating shaft 210 to achieve the same-direction differential rotation of the first semi-rotor 221 and the second semi-rotor 222. It effectively avoids the collision and damage of two adjacent rotor vanes 224, ensures the safe and stable operation of the rotor 200, and improves the fuel utilization efficiency of the rotor engine.

Referring to FIG. 8, the phase roller 310 includes a phase shaft 311 and a phase wheel 312. The phase shaft 311 extends along the axial direction of the rotating shaft 210, and the phase wheel 312 is rotatably sleeved on the phase shaft 311. The phase shaft 311 is fixedly connected to the rotor plate 223. When the phase roller 310 presses the movable part 330, the phase wheel 312 can roll on the movable part 330.

Referring to FIG. 18, the movable member 330 includes two movable walls 331, a connecting bearing 332 and two movable bearings 333. The two movable walls 331 extend along the arrangement direction of the phase roller 310, and both ends of the two movable walls 331 seal against the phase roller 310. The connecting bearing 332 and the movable bearing 333 are both located between the two movable walls 331. The connecting bearing 332 is located in the middle of the movable wall 331. The movable wall 331 is rotatably connected to one end of the fixed frame 320 through the connecting bearing 332. The movable bearing 333 is located at both ends of the movable wall 331 and partially exceeds the movable wall 331, so that the movable bearing 333 can be rotatably abutted against the guide ring 511. On the one hand, it can prevent the movable bearing 333 from interfering with the phase roller 310 during the rotation relative to the guide ring 511, thereby improving the reliability of the link mechanism 300. On the other hand, the phase roller 310 is supported on the movable wall 331, and the movable bearing 333 is supported on the guide ring 511, which can reduce the friction between the phase roller 310, the movable part 330, and the guide ring 511, increase the service life of the link mechanism 300 and the end cover 500, and ensure the safe and stable operation of the rotor 200 engine.

In some embodiments, the movable member 330 further includes a reinforcing wall 334. The reinforcing wall 334 is disposed on the side of the two movable walls 331 away from the rotating shaft 210. The reinforcing wall 334 is fixedly connected to the two movable walls 331 to enhance the structural strength of the movable member 330. In some embodiments, the movable member 330 may also be other structures that can realize the relative rotation of the semi-rotor 220 and the rotating shaft 210, and can realize the transmission connection between them.

In some embodiments, the two phase rollers 310 are arranged corresponding to the two rotor vanes 224 on the adjacent semi-rotors 220, and the arrangement direction of the two phase rollers 310 is the radial direction of the two rotor vanes 224. This can improve the connection strength between the semi-rotor 220 and the phase roller 310, and improve the reliability of the link mechanism 300.

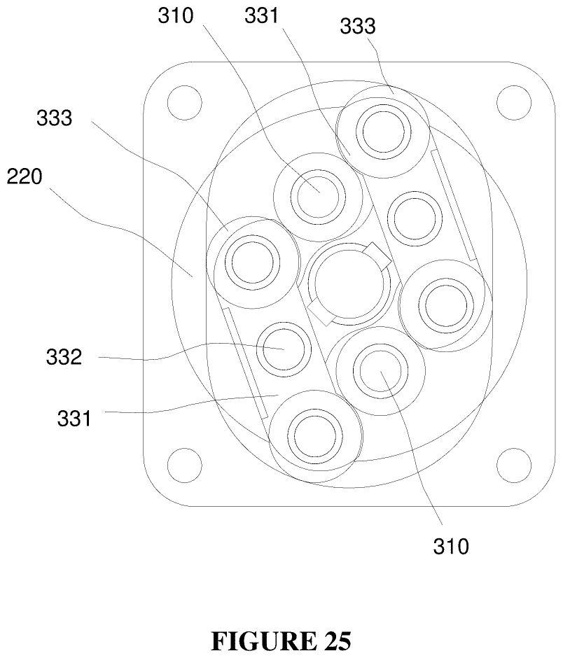

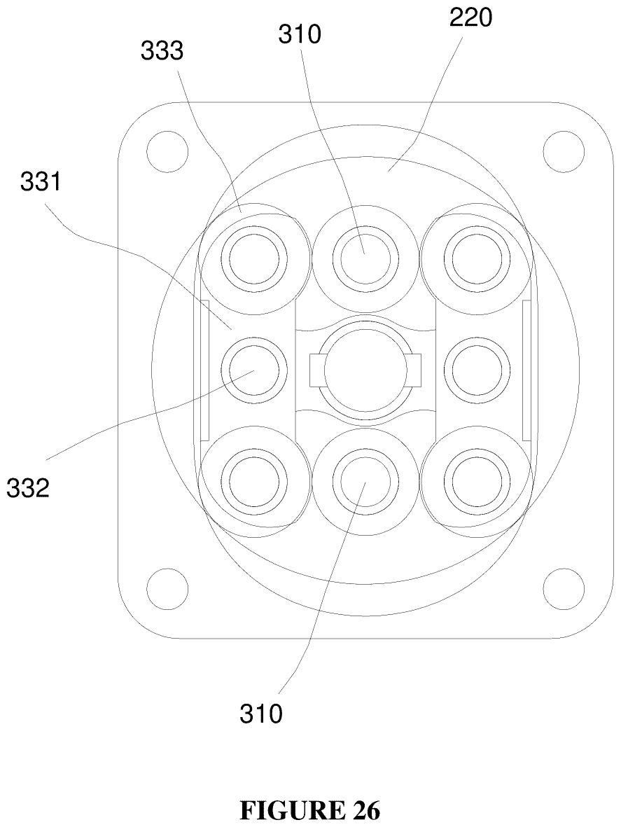

Referring to FIGS. 10 to 12 and FIGS. 24 to 26, which are the changes of the link mechanism 300 when the first working chamber 291 moves from the first working state to the third working state. At the beginning, the arrangement direction of the two-phase rollers 310 is perpendicular to the extension direction of the fixed frame 320 again. The third working chamber 293 is in the power stroke, and the second semi-rotor 222 drives the two-phase rollers 310 thereon to rotate clockwise to apply pressure to the adjacent movable walls 331 in the clockwise direction. During the extrusion process, the four movable bearings 333 on the two movable parts 330 all move along the guide ring 511. Secondly, the second working chamber 292 performs the power stroke again, and finally makes the arrangement direction of the two-phase rollers 310 perpendicular to the extension direction of the fixed frame 320 again. At this time, the first working chamber 291 reaches the third working state after passing through the second working state from the first working state, and the first working chamber 291 is performing the compression stroke.

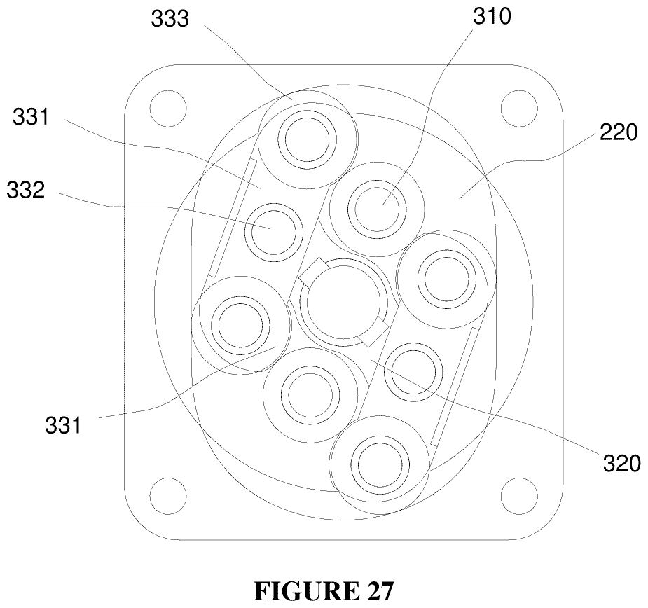

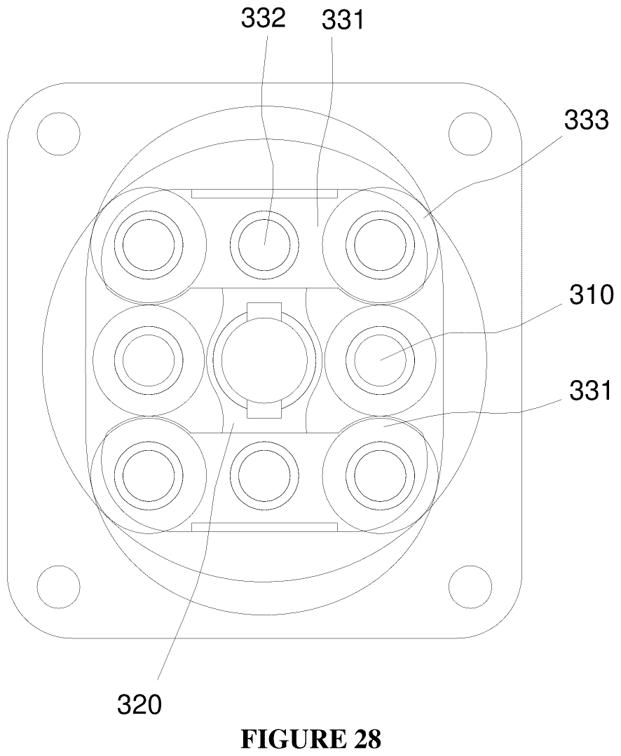

Referring to FIGS. 12 to 14 and FIGS. 26 to 28, which are the changes of the link mechanism 300 when the first working chamber 291 moves from the third working state to the fifth working state. At the beginning, the second working chamber 292 is in the power stroke, and the first semi-rotor 221 drives the two-phase rollers 310 thereon to rotate clockwise to apply pressure to the adjacent movable walls 331 in the clockwise direction. During the extrusion process, the four movable bearings 333 on the two movable parts 330 all move along the guide ring 511. Secondly, the first working chamber 291 performs a power stroke again to drive the second rotor plate 223 to rotate, and finally makes the arrangement direction of the two-phase rollers 310 perpendicular to the extension direction of the fixing frame 320 again. At this time, the first working chamber 291 reaches the fifth working state after the third working state through the fourth working state, and the first working chamber 291 is performing a power stroke.

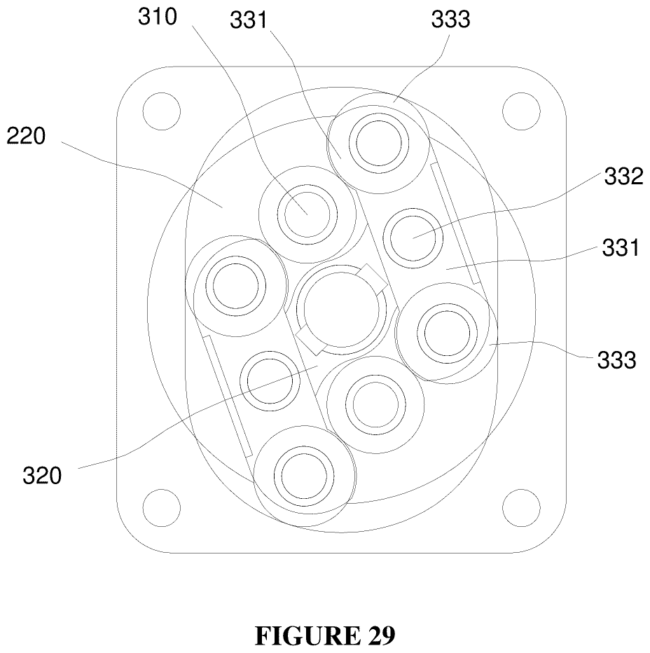

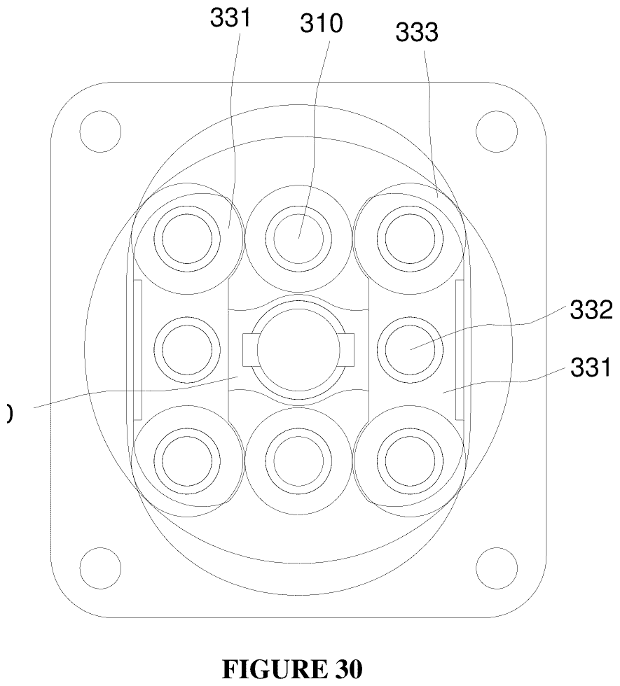

Referring to FIGS. 14 to 16 and FIGS. 28 to 30, which are the changes of the link mechanism 300 when the first working chamber 291 moves from the fifth working state to the seventh working state. At the beginning, the first working chamber 291 is in the power stroke, and the second semi-rotor 222 drives the two-phase rollers 310 thereon to rotate clockwise to apply pressure to the adjacent movable walls 331 in the clockwise direction. During the extrusion process, the four movable bearings 333 on the two movable parts 330 all move along the guide ring 511. Secondly, the fourth working chamber 294 performs a power stroke again to drive the first rotor plate 223 to rotate, and finally makes the arrangement direction of the two-phase rollers 310 perpendicular to the extension direction of the fixing frame 320 again. At this time, the first working chamber 291 reaches the seventh working state after the sixth working state from the fifth working state, and the first working chamber 291 is performing an exhaust stroke.

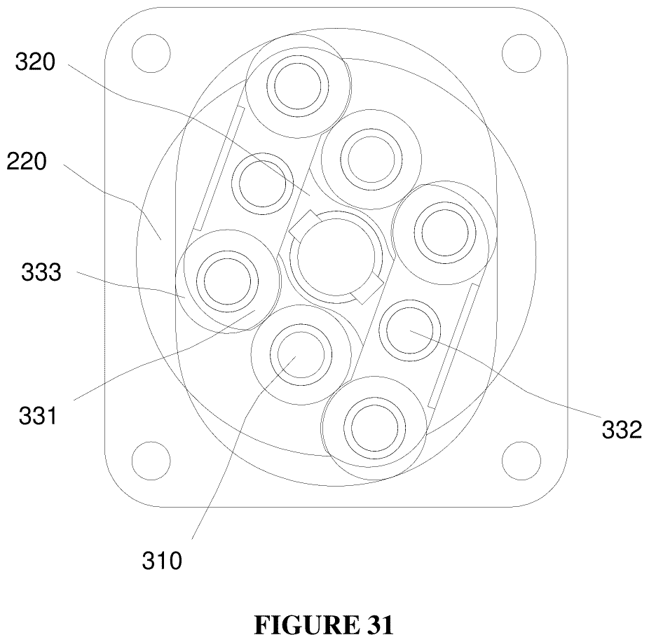

Referring to FIGS. 16, 17, 10, 30, 31 and 24, which are the changes of the link mechanism 300 when the first working chamber 291 moves from the seventh working state to the first working state. At the beginning, the fourth working chamber 294 is in the power stroke, and the first semi-rotor 221 drives the two-phase rollers 310 thereon to rotate clockwise to apply pressure to the adjacent movable walls 331 in the clockwise direction. During the extrusion process, the four movable bearings 333 on the two movable parts 330 all move along the guide ring 511. Secondly, the third working chamber 293 performs a power stroke again to drive the second rotor plate 223 to rotate, and finally makes the arrangement direction of the two-phase rollers 310 perpendicular to the extension direction of the fixing frame 320 again. At this time, the first working chamber 291 moves from the seventh working state to the first working state after passing through the eighth working state, and the first working chamber 291 is performing an intake stroke.

Referring to FIGS. 4 and 5, in this embodiment, both ends of the rotating shaft 210 are sleeved with rotating washers 410, and the rotating washers 410 seal against the rotor plate 223 to prevent the fixing frame 320 from abutting against the rotor plate 223, thereby preventing the rotating shaft 210 and the rotor plate 223 from being worn during relative rotation.

Referring to FIGS. 4 and 5, in the present embodiment, the rotating shaft 210 is detachably provided with a fixing pin 420 on the circumferential side of the rotating gasket 410, and the fixing frame 320 is provided with a fixing port 321 relative to the rotating shaft 210 and the fixing pin 420. The rotating shaft 210 and the fixing pin 420 can be accommodated in the fixing port 321, so that the fixing frame 320 can drive the rotating shaft 210 to rotate through the fixing pin 420.

In some embodiments, the output portion 212 of the rotating shaft 210 is provided with a fixing pin port 213 on the outer side of the rotating gasket 410, and the fixing pin port 213 extends perpendicular to the arrangement direction of the two-phase rollers 310, and the fixing pin port 213 is penetrated through the output portion 212 of the rotating shaft 210. The fixing pin 420 is detachably engaged in the fixing pin port 213, so that the limiter is fastened to the rotating gasket 410. It can fasten the two semi-rotors 220 and improve the structural strength of the rotor 200.

In some embodiments, the fixing frame 320 is supported on the rotating gasket 410 to facilitate relative rotation between the fixing frame 320 and the rotor plate 223.

In some embodiments, a fixing nut 430 is further provided on the outer side of the rotating shaft 210 and the link mechanism 300, and a thread is provided on the outer side of the fixing pin port 213 of the output portion 212 of the rotating shaft 210, and the output portion 212 is threadedly connected to the fixing nut 430, and the fixing nut 430 is supported on the fixing frame 320 to improve the connection strength between the fixing frame 320 and the rotating shaft 210.

Referring to FIGS. 19 and 20, in this embodiment, the end cover 500 is further provided with two crescent grooves 520 on one side wall of the recessed accommodation space 510, and the two crescent grooves 520 are arranged oppositely in the width direction of the guide ring 511. When the fuel in the working chamber of the rotor 200 suddenly explodes during the working process, the semi-rotor 220 may vibrate, and after the vibration is transmitted to the movable part 330 of the connecting mechanism, the movable wall 331 may seal against the guide ring 511 and wear each other. After the crescent groove 520 is provided, the wear area can be reduced and the service life of the link mechanism 300 can be increased.

In other embodiments, there may be multiple rotor vanes 224 on the rotor plate 223, and there may be multiple ignition ports 120, exhaust ports 130, and intake ports 140 on the cylinder body, as long as they can enable multiple working chambers to complete the stroke operation in sequence.

Referring to FIGS. 1 to 31, in the present application, when the rotor 200 is in operation, the driving device provides initial kinetic energy for the rotor 200. The driving device drives the rotating shaft 210 to rotate, and the rotating shaft 210 drives the two semi-rotors 220 to rotate around the rotating shaft 210 through the fixing frame 320, the movable member 330 and the phase roller 310.

During the clockwise rotation of the two semi-rotors 220, the semi-rotors 220 are in surface contact with the inner circumferential wall of the rotating shaft 210 and the rotor working space 110, and the sealing performance is good. The rotor 200 rotates from the first working state to the seventh working state in sequence, and continuously rotates from the seventh working state to rotate the rotor 200 back to the first working state, thereby completing a complete power stroke of a working chamber. The four working chambers perform intake, compression, working, and exhaust strokes in sequence, so that the rotor 200 engine can continuously receive the kinetic energy of fuel combustion during operation.

When the first semi-rotor 221 is subjected to the kinetic energy of the work done by the working chamber, the first semi-rotor 221 drives the phase shaft 311 bearing thereon to move, and the phase shaft 311 bearing, during the rotation process, abuts against and presses the movable wall 331. The movable wall 331 moves along the guide ring 511 after being subjected to the extrusion force, and the movable bearing 333 is rollingly connected with the guide ring 511. During the movement of the movable part 330, the movable part 330 and the fixed frame 320 have relative rotation with the connecting bearing 332 as the center, and during the relative rotation process, the fixed frame 320 rotates relative to the first semi-rotor 221 around the axis of the rotating shaft 210, and the fixed frame 320 drives the rotating shaft 210 to rotate around the axis of the rotating shaft 210.

After the rotating shaft 210 rotates, it drives the fixing frame 320 of the link mechanism 300 on the other side to rotate, and the fixing frame 320 on the other side drives the second semi-rotor 222 to rotate clockwise through the movable part 330 and the phase shaft 311. The first half rotor 221 and the second semi-rotor 222 can achieve synchronous and differential rotation, and the four working chambers continuously provide kinetic energy to the first semi-rotor 221 and the second semi-rotor 222, so that the rotor 200 engine can continuously provide kinetic energy to the outside world. It simplifies the transmission structure between the two semi-rotors 220 and improves the installation and disassembly efficiency of the rotor 200.

In the present application, during the operation of the rotor 200 engine, the working chamber sequentially undergoes intake, compression, power and exhaust strokes, so that multiple working chambers sequentially and uninterruptedly perform power strokes, so that the rotor 200 engine of the present application can continuously provide mechanical kinetic energy to the outside world through the rotating shaft 210. During the power process of the working chamber, both semi-rotors 220 rotate around the rotating shaft 210. During the rotation of the two semi-rotors 220, the inner side wall of the rotor vanes 224 abuts against the outer peripheral wall of the rotating shaft 210, and the outer side wall of the rotor vanes 224 abuts against the inner peripheral wall of the rotor working space 110, so that during the rotation of the rotor vanes 224, the contact type between the rotor vanes 224 and the rotating shaft 210 and the cylinder body is surface contact, which effectively reduces the wear between the rotor 200 and the cylinder body 100, improves the sealing between the rotor 200 and the cylinder body 100, and can effectively prevent the fuel in the working chamber from leaking to the outside world.

The above embodiments of the semi-rotor structure and the link mechanism are only the simplest exemplary descriptions. The structures in the embodiments are not fixed combination structures. In the absence of structural conflicts, the structures in multiple embodiments can be used in any combination.

It should be understood that a person skilled in the art can make equivalent substitutions or changes based on the technical solution and inventive concept of the present application, and all these changes or substitutions should fall within the protection scope of the claims attached to the present application.

What is claimed is:

1. A rotor engine, comprising:
a cylinder body, wherein a circular rotor working space runs through the inside of the cylinder body;
a rotor, which is arranged in the rotor working space, and the rotor comprises a rotating shaft and two oppositely arranged semi-rotors; the rotating shaft extends along the axis of the rotor working space; the semi-rotor comprises a rotor plate and a plurality of rotor vanes arranged on the rotor plate, the two rotor plates are sleeved on the rotating shaft at intervals, and the outer peripheral wall of the rotor plate abuts against the inner peripheral wall of the rotor working space; the plurality of rotor vanes on one rotor plate all extend along the axial direction of the rotating shaft to seal against the other rotor plate, and the angles between any two adjacent rotor vanes on the same rotor plate are equal, and the inner and outer side walls of the rotor vanes are respectively sealed against the outer peripheral wall of the rotating shaft and the inner peripheral wall of the rotor working space, and the inner peripheral wall of the rotor working space, the two adjacent rotor vanes, the two rotor plates and the rotating shaft enclose a working chamber for combustion and work;
two link mechanisms, are arranged on the outside of the rotor, and the link mechanisms are connected to the rotating shaft and the adjacent rotor plates, one semi-rotor rotates to drive the rotating shaft to rotate through the link mechanism, and the rotating shaft can drive the other semi-rotor to rotate through the other link mechanism, and an angle is formed between any two adjacent rotor vanes.

2. The rotor engine according to claim 1, wherein the rotor engine further comprises two end covers, the end covers are detachably covered on the two ends of the cylinder body, a receiving space is recessed on one side of the end cover facing the link mechanism, and the inner peripheral wall of the receiving space encloses a guide ring;
the link mechanism is accommodated in the accommodating space, and the link mechanism includes a phase roller, a fixed frame and a movable part, the phase roller is connected to the outer wall of the rotor plate to rotate with the rotor plate, the fixed frame is connected to the rotating shaft to rotate with the rotating shaft, and the movable part is rotatably connected to the fixed frame, the phase roller rotates around the rotating shaft to abut and squeeze the movable part, the movable part can abut the guide ring and move along the guide ring, and the movable part moves to drive the fixed frame and the rotating shaft to rotate.

3. The rotor engine according to claim 2, wherein the link mechanism includes two phase rollers, a fixed frame and two movable parts, the two phase rollers are symmetrically arranged with respect to the rotating shaft, the fixed frame extends in a direction perpendicular to the arrangement direction of the two phase rollers, the rotating shaft is accommodated in the middle of the fixed frame, a movable part is rotatably arranged at both ends of the fixed frame; the movable part extends along the arrangement direction of the phase rollers, the movable part includes two movable bearings arranged at both ends thereof, and the movable bearings are supported on the guide ring.

4. The rotor engine according to claim 3, wherein the movable part includes two movable walls, a connecting bearing and two movable bearings, the two movable walls extend along the arrangement direction of the phase rollers, both ends of the two movable walls are abutted against the phase rollers, the connecting bearing and the movable bearing are located between the two movable walls, the connecting bearing is located in the middle of the movable wall; the movable wall is rotatably connected to one end of the fixed frame through the connecting bearing, the movable bearing is located at both ends of the movable wall and partially exceeds the movable wall so that the movable bearing can be rotatably abutted against the guide ring.

5. The rotor engine according to claim 3, wherein the movable part further comprises a reinforcing wall, which is arranged on a side of the two movable walls away from the rotating shaft, and extends along an extending direction of the movable walls, and connects the two movable walls.

6. The rotor engine according to claim 2, wherein rotating washers are sleeved on both ends of the rotating shaft, and the rotating washers are abutted against the rotor plate, the rotating shaft is detachably provided with a fixing pin on the circumferential side of the rotating washers, and the fixing frame is provided with a fixing port relative to the rotating shaft and the fixing pin, and the rotating shaft and the fixing pin can be accommodated in the fixing port, so that the fixing frame can drive the rotating shaft to rotate through the fixing pin.

7. The rotor engine according to claim 2, wherein the end cover is further provided with two crescent grooves on a side wall where the accommodating space is recessed, and the two crescent grooves are arranged oppositely in the width direction of the guide ring.

8. The rotor engine according to claim 1, wherein a sealing strip is arranged on the outer peripheral wall of the rotor vanes, and the sealing strip extends along the axial direction of the rotating shaft, the sealing strip seals against the inner peripheral wall of the rotor working space.

9. The rotor engine according to claim 1, wherein a shaft limiting groove is recessed on the circumferential side of the shaft on one side wall of the two rotor plates facing each other, the shaft includes a sealing portion and output portions arranged at both axial ends of the sealing portion, both ends of the sealing portion are accommodated in the shaft limiting groove, the outer peripheral seal of the sealing portion is abutted against the inner side surface of the rotor vanes, the output portion passes through the adjacent rotor plate and is connected to the link mechanism.

10. The rotor engine according to claim 9, wherein the inner wall of the rotor vanes extends in an arc shape relative to the rotating shaft so that the circumferential side wall of the sealing portion fits against the inner wall of the rotor vanes, the outer wall of the rotor vanes extends in an arc shape relative to the inner circumferential side wall of the rotor working space so that the outer wall of the rotor vanes can fit against the inner circumferential wall of the rotor working space.

11. The rotor engine according to claim 1, wherein the semi-rotor comprises the rotor plate and two rotor vanes, and the angle between the two rotor vanes is 180°.

12. The rotor engine according to claim 1, wherein the cylinder body is provided with an air inlet port, an ignition port and an exhaust port on the inner circumferential wall of the rotor working space, the air inlet port is used for external fuel to enter the working chamber, the ignition port is used to ignite the fuel entering the working chamber, the exhaust port is used to discharge the exhaust gas after combustion, in the rotation direction of the rotor, the ignition port, the exhaust port and the air inlet port are arranged in sequence on the inner circumferential wall of the cylinder body.

13. The rotor engine according to claim 12, wherein the air inlet and the air exhaust are arranged adjacent to each other on the same side of the cylinder body, the ignition port and the air inlet are arranged on two opposite sides of the cylinder body respectively.

14. The rotor engine according to claim 1, wherein the outer side wall of the rotor plate is parallel to the end surface of the cylinder body along the axial direction of the rotating shaft.

15. The rotor engine according to claim 1, wherein in the radial direction of the rotating shaft, the circumferential dimension of the rotor vanes gradually increases, in the circumferential direction of the rotating shaft, an angle is formed between the two side walls of the rotor vanes.
